(19) United States
(12) Patent Application Publication
(10) Pub. No.: US 2015/0106735 A1
(43) Pub. Date: Apr. 16, 2015

(54) SYSTEM AND METHOD FOR A GRAPHICAL USER INTERFACE OPERABLE FOR USER TASTE CONFIGURATION

(71) Applicant: Kobo Incorporated, Toronto (CA)

(72) Inventor: James WU, Toronto (CA)

(73) Assignee: Kobo Incorporated, Toronto (CA)

(21) Appl. No.: 14/055,142

(22) Filed: Oct. 16, 2013

(51) Int. Cl. G06F 3/0482; G06F 3/0484

(52) U.S. Cl. CPC G06F 3/0482; G06F 3/04842
USPC 715/745

(57) ABSTRACT

A system and method for a graphical user interface operable for configuration of a user profile. The method includes accessing, within a mobile device, a data store corresponding to a plurality of pieces of content and displaying a first image corresponding to a first piece of content of the plurality of pieces of content. The first image is displayed in a first area of a display device. The method further includes receiving a first user input corresponding to a movement of the first image and determining whether the first image has been moved into a second area of the display device. In response to the first image being moved into the second area of the display device, the first image is displayed in the second area of the display device. The method further includes updating a user profile with a first indicator that the user is interested in the first piece of content corresponding to the first image.

### CROSS REFERENCE TO RELATED APPLICATIONS

This application is related to copending non-provisional patent application, Ser. No. 13/601,363, Attorney Docket Number KOBO-0001, entitled “SYSTEM AND METHOD FOR A MULTIMEDIA CONTAINER,” with filing date May 23, 2013, and hereby incorporated by reference in its entirety.

This application is related to copending non-provisional patent application, Ser. No. 13/601,426, Attorney Docket Number KOBO-0002, entitled “SYSTEM AND METHOD FOR MANAGING OBJECTS IN A MULTIMEDIA CONTAINER,” with filing date May 23, 2013, and hereby incorporated by reference in its entirety.

This application is related to copending non-provisional patent application, Ser. No. 13/601,465, Attorney Docket Number KOBO-0003, entitled “SYSTEM AND METHOD FOR DISPLAYING A MULTIMEDIA CONTAINER,” with filing date May 23, 2013, and hereby incorporated by reference in its entirety.

This application is related to copending non-provisional patent application, Ser. No. 13/601,468, Attorney Docket Number KOBO-0004, entitled “SYSTEM AND METHOD FOR A HOME MULTIMEDIA CONTAINER,” with filing date May 23, 2013, and hereby incorporated by reference in its entirety.

This application is related to non-provisional patent application, Ser. No. 13/631,563, Attorney Docket Number KOBO-0005, entitled “SYSTEM AND METHOD FOR A GRAPHICAL USER INTERFACE INCLUDING RECOMMENDATIONS,” with filing date Jun. 28, 2013, and hereby incorporated by reference in its entirety.

This application is related to non-provisional patent application, Ser. No. 14/016,670, Attorney Docket Number KOBO-0028, entitled “SYSTEM AND METHOD FOR A GRAPHICAL USER INTERFACE HAVING A RESIZABLE RECOMMENDATIONS AREA,” with filing date Sep. 3, 2013, and hereby incorporated by reference in its entirety.

This application is related to non-provisional patent application, Ser. No. 13/948,941, Attorney Docket Number KOBO-0006, entitled “SYSTEM AND METHOD FOR A GRAPHICAL USER INTERFACE INCLUDING RECOMMENDATIONS,” with filing date Jul. 23, 2013, and hereby incorporated by reference in its entirety.

### FIELD OF THE INVENTION

Embodiments of the present invention are generally related to graphical user interfaces that may be part of a mobile device operating system.

### BACKGROUND

As computing technology has advanced, computers have become smaller and more portable thereby bringing about powerful handheld devices capable of performing functions of more traditional computing technology. At the same time operating systems for handheld devices or mobile devices have been developed to better suit handheld devices. These advances in mobile devices have lead to substantially increased usage of mobile device for an increasing number of tasks.

When a user is browsing an electronic content store, the user may be presented with recommended items in an effort to encourage a user to buy more items. The recommended items may be based on information known about the user, such as past purchases. Conventional interfaces may allow a user to make choices to allow the store to learn about the user and are targeted at users with desktop computer systems. For example, a conventional interface may have an item disappear after a user has input his or her review of the item or the interface may require that a user mouse over the content item to be presented with options. Thus, the conventional interfaces are not very intuitive.

### SUMMARY OF THE INVENTION

Accordingly, what is needed is a solution providing an intuitive and interesting interface for a user to input or express their interests and ratings for piece of content to allow user's to enable more accurate recommended pieces of content. Embodiments of the present invention allow a user to input interest and rating information related to a plurality of pieces of content thereby allowing embodiments of the present invention to configure a user profile according to the user's tastes or preferences. Recommendations may then be updated or generated based on the user profile. Embodiments of the present invention further allow a user to visually move around each of a plurality of images each representing a piece of content to indicate interest in the piece of content. Pieces of content may further be recategorized (e.g., from interest to disinterest) and the user profile updated accordingly. Embodiments of the present invention thereby provide an intuitive interface for inputting a user's tastes or preferences.

In one embodiment, the present invention is directed to a method for rendering a graphical user interface. The method includes accessing, within a mobile device, a data store corresponding to a plurality of pieces of content and displaying a first image corresponding to a first piece of content of the plurality of pieces of content. The first image is displayed in a first area of a display device. The method further includes receiving a first user input corresponding to a movement of the first image and determining whether the first image has been moved into a second area of the display device. In response to the first image being moved into the second area of the display device, the first image is displayed in the second area of the display device. The method further includes updating a user profile with a first indicator that the user is interested in the first piece of content corresponding to the first image. The method may further include displaying a second image corresponding to a second piece of content of the plurality of pieces of content.

In one embodiment, the method further includes determining whether the first image has been moved in a third area of the display device. In response to the first image being moved into the third area of the display device, the first image is displayed in the third area of the display device. The method further includes updating the user profile with a second indicator that the user is disinterested in the first piece of content corresponding to the first image. The method may further include displaying a second image corresponding to a second piece of content of the plurality of pieces of content.

In one embodiment, the method may include receiving a second user input corresponding to a user indication that the user has previously consumed the first piece of content. The method may further includes receiving a third user input corresponding to a rating of the first piece of content. In one exemplary embodiment, the method further includes receiving a second user input to move the first image from the second area of the display device. In response to the second user input, whether the first image has been moved in a third area of the display device is determined. In response to the first image being moved into the third area of the display device, displaying the first image in the third area of the display device. The method further includes updating the user profile with a second indicator that the user is disinterested in the first piece of content corresponding to the first image.

In one embodiment, the present invention is directed to a method for configuring a user profile via a graphical user interface. The method includes accessing, within a mobile device, a data store corresponding to a plurality of electronic publications and displaying a first electronic publication cover image corresponding to a first electronic publication of the plurality of electronic publication. The first electronic publication cover image is displayed in a first area of a display device. The method further includes receiving a first user input corresponding to a movement of the first electronic publication cover image and determining whether the first electronic publication cover image has been moved into a second area of the display device. The second area is operable to display a first set of respective images corresponding to electronic publications associated with an expressed user interest. In response to the first electronic publication cover image being moved into the second area of the display device, the first electronic publication cover image is displayed in the second area of the display device. The method further includes updating a user profile with a first indicator that the user is interested in the first electronic publication corresponding to the first electronic publication cover image.

The method may further include determining whether the first electronic publication cover image has been moved in a third area of the display device. The third area is operable to display a second set of respective images corresponding to electronic publications that a user has expressed a disinterest in. In response to the first electronic publication cover image being moved into the third area of the display device, displaying the first electronic publication cover image in the third area of the display device. The method may further include updating the user profile with a second indicator that the user is disinterested in the first electronic publication corresponding to the first image.

In one embodiment, the method includes displaying a second electronic publication cover image corresponding to a second piece of content of the plurality of pieces of content. The second electronic publication cover image displayed in the first area of the display device. In one exemplary embodiment, the method further includes receiving a second user input corresponding to a user indication that the user has previously consumed the first electronic publication. The method may further include receiving a third user input corresponding to a rating of the first piece of content.

In one embodiment, the method further includes receiving a second user input to move the first electronic publication cover image from the second area of the display device. In response to the second user input, whether the first electronic publication cover image has been moved to a third area of the display device is determined. In response to the first electronic publication cover image being moved into the third area of the display device, the first electronic publication cover image is displayed in the third area of the display device. The method may further include updating the user profile with a second indicator that the user is disinterested in the first publication corresponding to the first electronic publication cover image. In one exemplary embodiment, the method may further include receiving a second user input to move the first electronic publication cover image from the third area of the display device. In response to the second user input, whether the first electronic publication cover image has been moved into the second area of the display device is determined. In response to the first electronic publication cover image being moved into the second area of the display device, displaying the first electronic publication cover image in the second area of the display device. The method may further include updating the user profile with a second indicator that the user is interested in the first publication corresponding to the first electronic publication cover image.

In another embodiment, the present invention is implemented as a system for rendering a graphical user interface. The system includes a data store access module operable to access a data store corresponding to a plurality of pieces of electronic content and a display module operable to display a respective image for each of the plurality of pieces of content. The system further includes an input module operable to receive a motion input associated with a first respective image and an interest determination module operable to determine whether the first respective image has been moved to at least one of a first area of a display device and second area of the display device. The first area of a display device corresponds to the user being interested in a respective piece of electronic content corresponding to the first respective image and the second area of the display device corresponds to the user being disinterested in the respective piece of electronic content corresponding to the first respective image. The system further includes a profile module operable to update a user profile based on a determination by the interest determination module. In one embodiment, the input module is further operable for receiving a second motion input with respect to the first respective image moving from at least one of the first area of the display device and the second area of the display device. In one exemplary embodiment, the input module is further operable to receive input of a rating corresponding a piece of content of the plurality of pieces of content.

In one embodiment, the display module is further operable to display the first respective image in the first area of the display device in response to the first respective image being moved to the first area of the display device. In one exemplary embodiment, the display module is further operable to display the first respective image in the second area of the display device in response to the first respective image being moved to the second area of the display device. In one embodiment, the display module is operable to display a second respective image corresponding to the piece of content of the plurality of pieces of content in the first area of the display device in response to the input module receiving the rating corresponding to the piece of content of the plurality of pieces of content.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows an exemplary graphical user interface for a multimedia container having a user profile configuration application, in accordance with one embodiment of the present invention.

FIG. 2 shows an exemplary graphical user interface operable for displaying information about a user profile configuration application, in accordance with one embodiment of the present invention.

FIG. 3 shows an exemplary graphical user interface operable for categorizing pieces of content to configure a user's tastes within a user profile, in accordance with one embodiment of the present invention.

FIG. 4 shows an exemplary graphical user interface during movement of an image corresponding a piece of content into an area indicating a user's interest in the piece of content, in accordance with one embodiment of the present invention.

FIG. 5 shows an exemplary graphical user interface during movement of an image corresponding a piece of content into an area indicating a user's disinterest in the piece of content, in accordance with one embodiment of the present invention.

FIG. 6 shows an exemplary graphical user interface for inputting a rating of a piece of content, in accordance with one embodiment of the present invention.

FIG. 7 shows an exemplary graphical user interface for inputting a rating of a piece of content after a rating has been selected, in accordance with one embodiment of the present invention.

FIG. 8 shows an exemplary graphical user interface for rendering a description of a piece of content, in accordance with one embodiment of the present invention.

FIG. 9 shows a flowchart of an exemplary computer controlled process for rendering a graphical user interface for configuring a user profile, in accordance with one embodiment of the present invention.

FIG. 10 shows a block diagram of an exemplary computing system and corresponding modules, in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

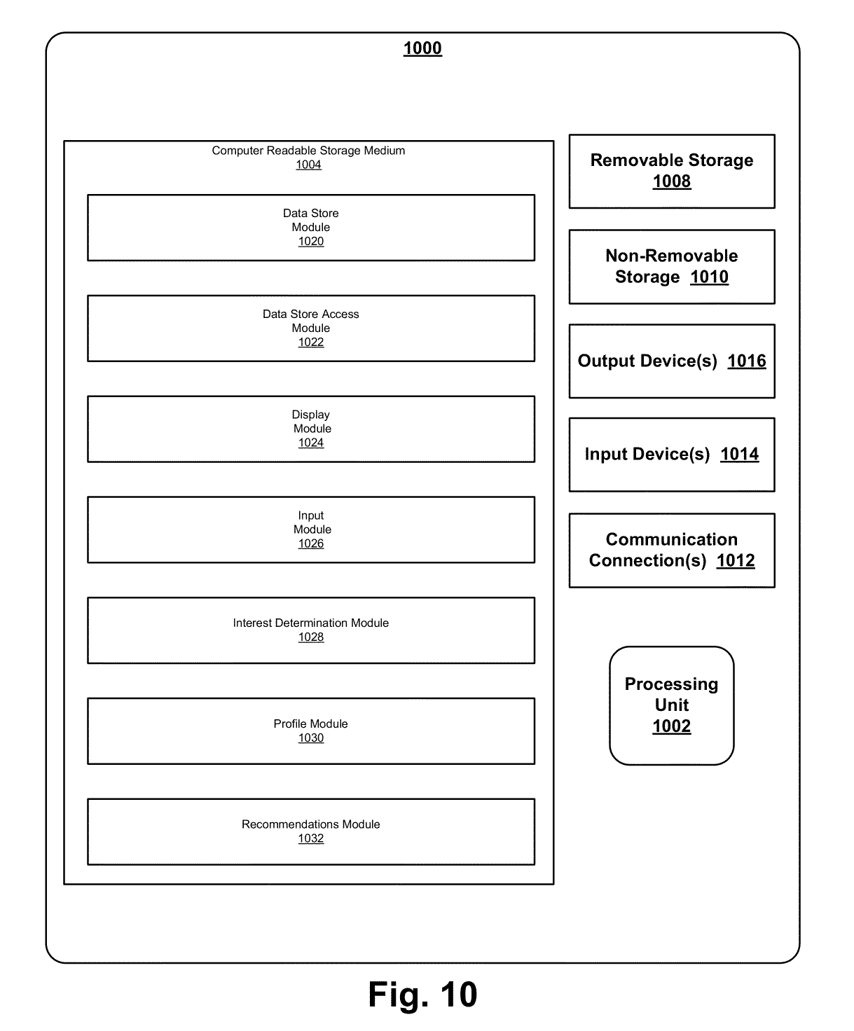

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “ processing” or “accessing” or “ executing” or “ storing” or “rendering” or the like, refer to the action and processes of an integrated circuit (e.g., system 1000 of FIG. 10), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods for a Graphical User Interface Operable for User Taste Configuration

Embodiments of the present invention allow a user to input interest and rating information related to a plurality of pieces of content thereby allowing embodiments of the present invention to configure a user profile according to the user's tastes or preferences. Recommendations may then be updated or generated based on the user profile. Embodiments of the present invention further allow a user to visually move around each of a plurality of images each representing a piece of content to indicate interest in the piece of content. Pieces of content may further be recategorized (e.g., from interest to disinterest) and the user profile updated. Embodiments of the present invention thereby provide an intuitive interface for inputting a user's tastes or preferences.

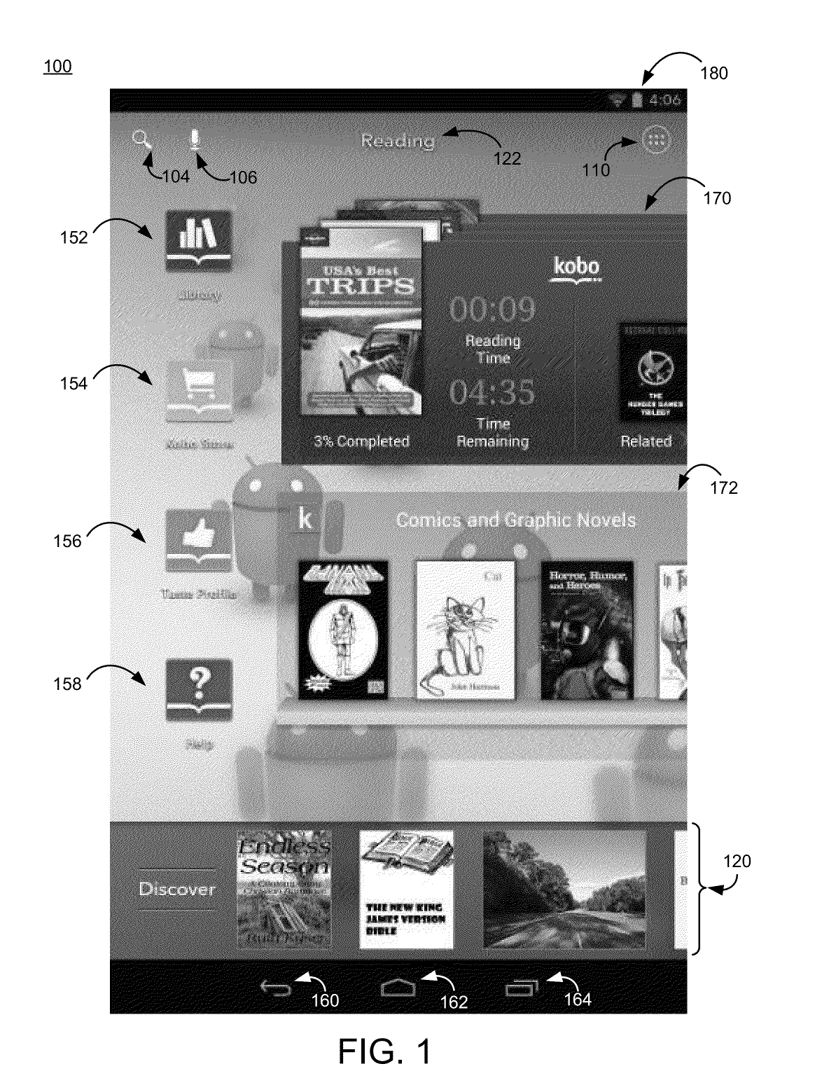

FIGS. 1-8 illustrate example components used by various embodiments of the present invention. Although specific components are disclosed in FIGS. 1-8, it should be appreciated that such components are exemplary. That is, embodiments of the present invention are well suited to having various other components or variations of the components recited in FIGS. 1-8. It is appreciated that the components in FIGS. 1-8 may operate with other components than those presented, and that not all of the components of FIGS. 1-8 may be required to achieve the goals of embodiments of the present invention.

FIG. 1 shows an exemplary graphical user interface for a multimedia container having a user profile configuration application, in accordance with one embodiment of the present invention. FIG. 1 depicts an exemplary graphical user interface comprising an exemplary multimedia container displayed by a device (e.g., tablet computing device, mobile phone, smartphone, or the like) and a recommendations area. In one embodiment, FIG. 1 further depicts an exemplary graphical user interface 100 comprising an exemplary multimedia container displayed by a device (e.g., mobile computing device, tablet computing device, mobile phone, smartphone, etc.). In exemplary embodiment, exemplary graphical user interface 100 may be rendered or displayed on a touch sensitive screen (e.g., capacitive touch screen) operable to receive input (e.g., from a user via one or more fingers) and display a graphical user interface.

FIG. 1 depicts an exemplary graphical user interface 100 comprising a portion of a multimedia container (e.g., a reading multimedia container) having applications and widgets that allow access to various reading related pieces of content. Exemplary graphical user interface 100 includes status area 180, search icon 104, voice recognition icon 106, applications icon 110, application icons 152-158, library widget 170, merchandising widget 172, container name 122, and exemplary recommendation area 120, and control icons 160-164. In one exemplary embodiment, applications 152-158 are organized on the left (e.g., top to bottom) and a plurality of widgets (e.g., library widget 170 and merchandising widget 172) related to reading are located to the right.

Search icon 104 is operable for invoking display of a graphical user interface for searching a device (e.g., the device displaying the graphical user interface) and other contents sources (e.g., Internet coupled content sources). Voice recognition icon 106 is operable for invoking display of a graphical user interface with voice recognition functionality for interacting with a device (e.g., functionality of the device to act as an assistant such as to add appointments) and for invoking search functionality.

Applications icon 110 is operable for invoking display of a graphical user interface for browsing application icons and launching corresponding applications. In one embodiment, the graphical user interface for browsing applications is organized into multiple pages of application icons.

Status area 180 includes information of the current status of the device. In one exemplary embodiment, status area 208 may include battery status, cellular service strength, Wi-Fi strength, and current time.

Control icons 160-164 are operable for navigation of a plurality of multimedia containers and switching applications. Back control 160 is operable for navigation to a previous multimedia container. Home control 162 is operable for navigating to a home multimedia container. Recent applications button 164 is operable to invoke a function for changing or switching applications.

In one exemplary embodiment, exemplary graphical user interface 100 depicts a reading multimedia container with container name 122 of “Reading.” The reading multimedia container may be a multimedia container operable to include objects (e.g., applications, widgets, and pieces of content such as books) related to reading and allow a user to quickly access one or more electronic publications. A user may add content (e.g., electronic books, music, and websites), applications, widgets, etc. and thereby customize the reading multimedia container.

Application icons 152-158 correspond to applications related to reading. In one exemplary embodiment, application icons 152-158 are located on a left side column of a reading multimedia container and extend from the top to bottom of the multimedia container. In one embodiment, application icon 152 when selected launches a library application operable to allow a user to access and/or browse electronic publications within the user's library (e.g., purchased, borrowed, and free electronic books). Application icon 154 when selected launches a store or marketplace application where a user can browse and download electronic publications (e.g., download purchased or free books). Application icon 156 when selected launches an application for a user to configure his or her profile, as described herein. Application icon 158 when selected launches a help application operable to help a user with reading electronic publications and answer electronic book related issues and questions.

Library widget 170 is operable to display information corresponding to each electronic publication in a user's personal library. In one exemplary embodiment, each electronic book of a user's personal library is represented by an image (e.g., similar to an index card) comprising an image of the book cover, statistics about the user's reading of the book (e.g. based on a user's reading patterns), and related or recommended books. The statistics about the user's reading of the book may include the percent completed or the amount (e.g., paragraphs or pages in an electronic publication (EPUB) format) of the book that the user has read, the time spent reading the book so far (e.g., in seconds and minutes), and the time (e.g., estimated) remaining to finish reading the book. The time remaining to finish reading the book may be calculated based on the rate as which the user has read a portion of the book in a tracked amount of reading time. The statistics about the user's reading of a book may be estimated or predicted.

Merchandising widget 172 is operable to display book covers of a plurality of electronic publications for a particular category. In one embodiment, the book covers of the plurality of books are depicted on a shelf or book shelf The plurality of books may have been determined based on the category and current selling goals (e.g., of a merchandising department).

Recommendation area 120 displays recommended items (e.g., pieces of content, applications, widgets, etc.) based on the contents of the reading multimedia container. The recommendations may be based on a user profile which may comprise a user's tastes based on ratings or expressed interested in pieces of content (e.g., electronic publications, music, video, websites, etc.), as described herein. In one exemplary embodiment, the recommendations of recommendation area 120 are further based on the electronic book that the user is currently reading (e.g., based on the contents of the most recently accessed electronic book).

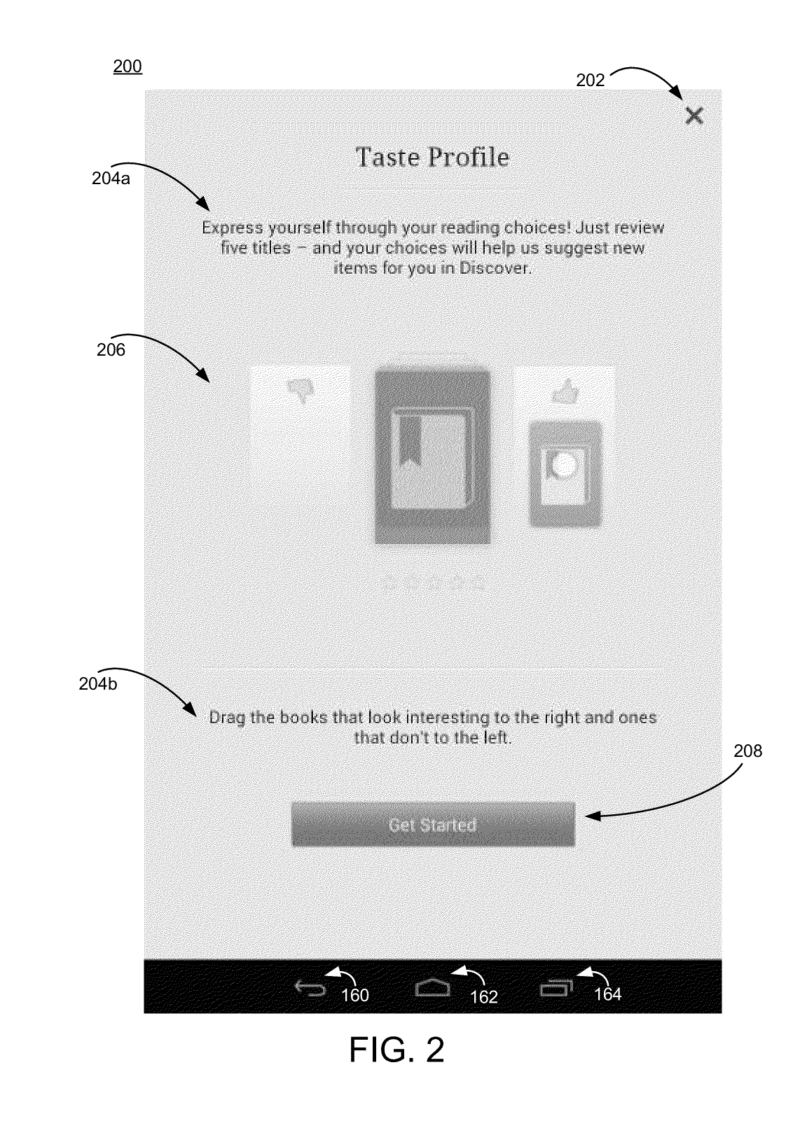

FIG. 2 shows an exemplary graphical user interface operable for displaying information about a user profile configuration application, in accordance with one embodiment of the present invention. FIG. 2 depicts an exemplary graphical user interface 200 having introductory information (e.g., a tutorial) to assist a user in using a profile configuration application. In one embodiment, exemplary graphical user interface 200 includes elements similar to exemplary graphical user interface 100.

In one embodiment, exemplary graphical user interface 200 includes close button 202, text areas 204a-b, animation or video area 206, and get started button 208. Close button 202 is operable for closing graphical user interface 200 and exiting the user profile configuration application. In one embodiment, graphical user interface 100 is rendered or displayed upon closing of the user profile configuration application. Text areas 204a-b may comprise text with instructions and other description of how to use a profile configuration application.

Animation or video area 206 is operable to display animation, video, or other depiction of interaction with a user profile configuration application. For example, animation or video area 206 may show an animation of a user dragging a book cover image to a thumb-up area or a thumbs-down area. Get started button 208 is operable for invoking user profile configuration functionality of user profile configuration application (e.g., exemplary graphical user interface 300), as described herein.

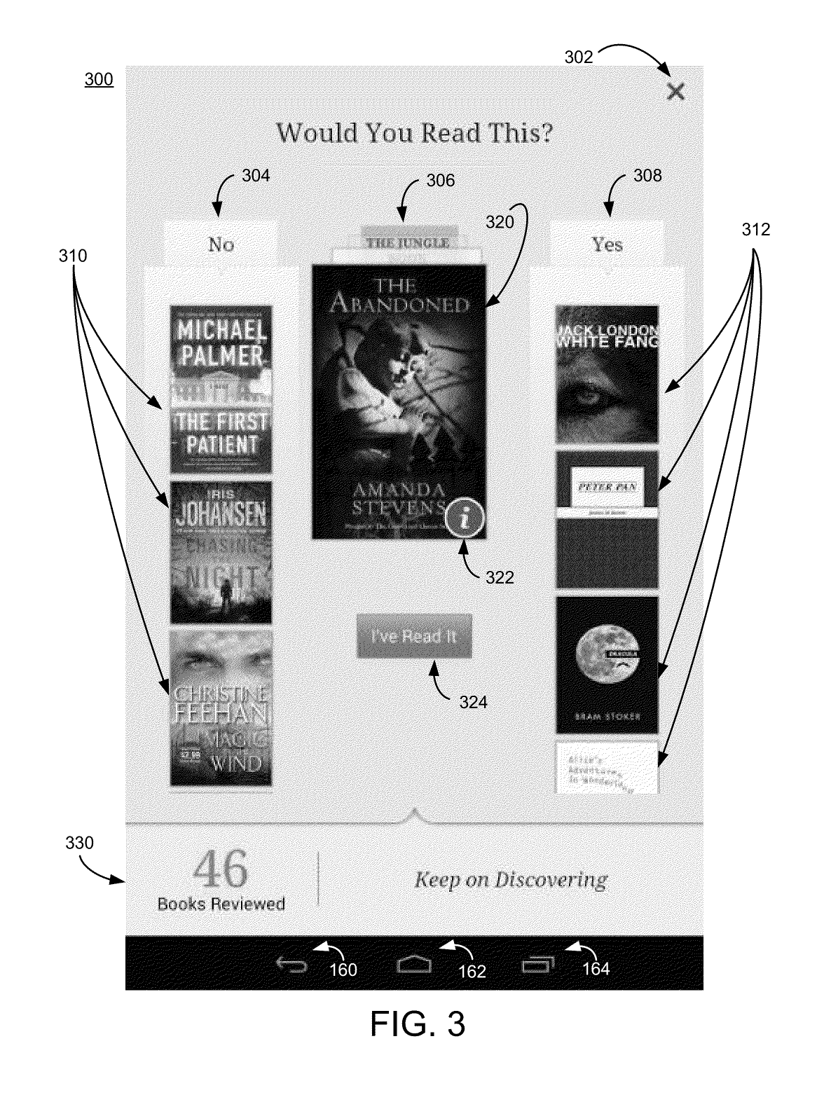

FIG. 3 shows an exemplary graphical user interface operable for categorizing pieces of content to configure a user's tastes within a user profile, in accordance with one embodiment of the present invention. FIG. 3 depicts an exemplary graphical user interface 300 of user profile configuration application where a user can indicate the he or she is interested in, disinterested in, or has previously consumed a piece of content. In one embodiment, exemplary graphical user interface 300 includes elements similar to exemplary graphical user interface 200.

In one embodiment, exemplary graphical user interface 300 includes close button 302, area 304, area 306, area 308, pieces of content images 310, piece of content images 312, piece of content image 320, button 324, and statistic 330. Close button 302 is operable for closing graphical user interface 300 and exiting the user profile configuration application. In one embodiment, graphical user interface 100 is rendered upon closing of the user profile configuration application.

Area 304 is operable for displaying pieces of content that a user has indicated or expressed disinterest in or dislikes. Area 304 is further operable for having an image corresponding to a piece of content that the user is not interested in dragged or moved thereto. In one exemplary embodiment, area 304 is a column displayed on a left side portion of a display device having a “No” label corresponding to a displayed “Would you read this?” label.

Area 306 is operable for displaying a plurality of images each corresponding to a respective piece of content for a user to indicate whether he or she is interested in, disinterested in, or has previously consumed. In one embodiment, area 306 displays a pile of electronic publication images (e.g., book cover images that are offset and showing portions thereof). The images of area 306 may be displayed in an animated fashion after an image of area 306 is moved to area 304 or area 308.

Area 308 is operable for displaying pieces of content that a user has indicated or expressed interest in or likes. Area 308 is further operable for having an image corresponding to piece of content that the user is interested in dragged or moved thereto. In one exemplary embodiment, area 304 is a column displayed on a right side portion of a display device having a “Yes” label corresponding to a displayed “Would you read this?” label.

As pieces of the content are added to area 308 via images representing each of the pieces of content, recommendations based on the pieces of content are determined. The recommendations may then be displayed in a recommendation area (e.g., recommendation area 120). As pieces of the content are added to area 304 via images representing each of the pieces of content, recommendations based on the pieces of content may not be made or recommendations may be removed from previously determined recommendations. The recommendations (e.g., remaining recommendations) may then be displayed in recommendation area (e.g., recommendation area 120). Thus, upon an image corresponding to a piece of content being moved to area 304 or 308, the recommendations may be updated.

Pieces of content images 310 correspond to pieces of content that a user has indicated or expressed disinterest in or dislikes. Pieces of content images 310 may be displayed in area 304. Pieces of content images 310 may be advanced (e.g., downward) as an image from area 306 is moved into area 304.

Piece of content images 312 correspond to pieces of content that a user has indicated or expressed interest in or likes. Pieces of content images 312 may be displayed in area 308. Pieces of content images 312 may be advanced (e.g., downward) as an image from area 306 is moved into area 308.

Pieces of content image 310 and 312 may be individually selected and moved (e.g., dragged) from one area to another area thereby allowing a user to change or correct an expressed interest in a piece of content. For example, one image of piece of content images 310 may be moved from area 304 to area 308 and the one image of piece of content images 310 will be displayed in area 308. As another example, one image of piece of content images 312 may be moved from area 308 to area 304 and the one image of piece of content images 312 now being displayed in area 304. The user profile (e.g., user's tastes of the user profile) may then be updated to reflect an interest or disinterest in the piece of content corresponding to the image moved to a new area (e.g., from area 304 to area 308 indicating interest or area 308 to area 304 indicating disinterested). Recommendation may then be updated based on the updated user profile.

Piece of content image 320 corresponds to a piece of content of area 306. In one exemplary embodiment, piece of content image 320 corresponds to the cover of an electronic publication (e.g., book, novel, paper, magazine, etc.). In one embodiment, piece of content image 320 is enlarged in relation to other images in area 306 (e.g., the image at the top of the pile in area 306 is enlarged). Piece of content image 320 may be dragged or moved to area 304 to enable a user to configure the user's profile to reflect that the user is not interested in the piece of content corresponding to piece of content image 320. Piece of content image 320 may also be dragged or moved to area 308 to enable a user to configure the user's profile to reflect that the user is interested in the piece of content corresponding to piece of content image 320.

Piece of content image 320 includes information icon 322. Information icon 302 is operable for invoking display of a graphical user interface (e.g., graphical user interface 800) which includes descriptive information about the piece of content corresponding to piece of content image 320.

Button 324 is operable for a user to indicate the user has previously consumed (e.g., read, viewed, listened to, etc.) the piece of content corresponding to piece of content image 320. Button 324 may be operable for invoking a graphical user interface for rating a piece of content (e.g., exemplary graphical user interface 600). In one embodiment, button 324 is useful in cases where a user has consumed a piece of content already and may not be interested in consuming the piece of content again thereby avoiding a user expressing disinterest in a piece of content that could be useful for configuring the user profile. For example, where the user is prompted with the question of if he or she would read a piece of content, a user might think to answer “no” if he or she has already read the piece of content. Button 324 thereby allows embodiments of the present invention to learn a user's tastes or preferences without mischaracterizations based on the user already consuming the piece of content.

Statistic 330 is operable to display statistics related to a users interactions with a user profile configuration application. In one exemplary embodiment, statistic 330 includes a number of books reviewed (e.g., books that the user has rated or indicated an interest or disinterest in). Statistic 330 may allow a user to track the number of pieces of content that the user has reviewed and may add a game like aspect to the use of the user profile configuration application.

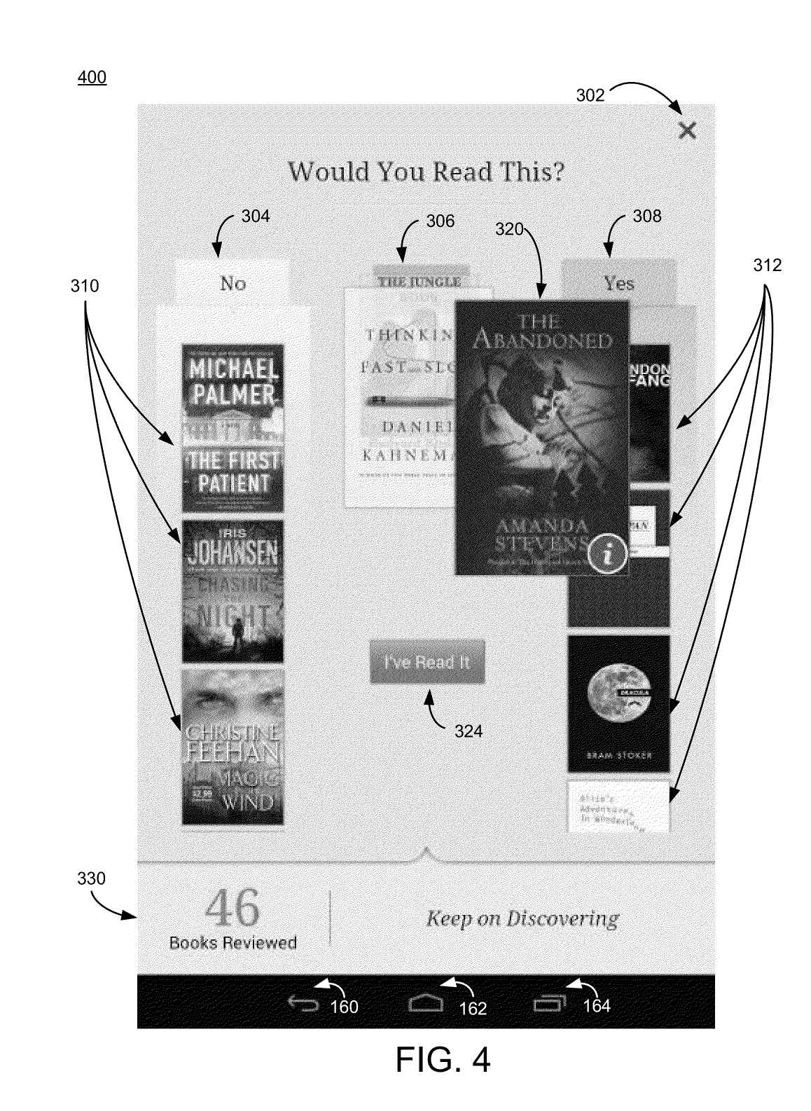

FIG. 4 shows an exemplary graphical user interface during movement of an image corresponding a piece of content into an area indicating a user's interest in the piece of content, in accordance with one embodiment of the present invention. FIG. 4 depicts exemplary graphical user interface 400 with an image corresponding to a piece of content being moved (e.g., dragged into) an area corresponding to user being interested in the piece of content. In one embodiment, exemplary graphical user interface 400 includes elements similar to exemplary graphical user interface 300.

In one embodiment, exemplary graphical user interface 400 shows a portion of piece of content image 320 being moved into area 308. In one exemplary embodiment, area 308 is highlighted (e.g., a background color and outline of area 308 are changed in color) based on a portion of piece of image 320 being moved within area 308. Piece of content image 320 may then be added to area 308 if a user releases (e.g., via lifting his or her finger from a touch screen) piece of content image 320. Piece of content image 320 may then be displayed as one of piece of content images 312 in area 308.

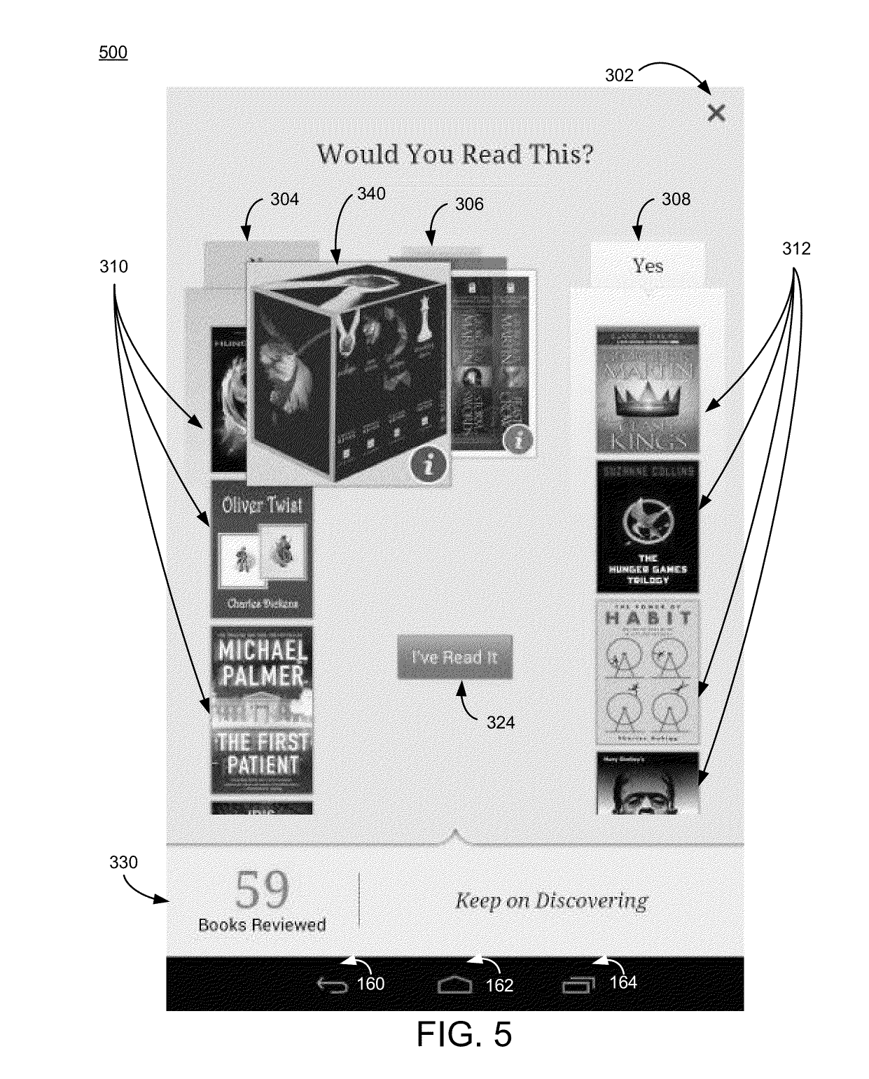

FIG. 5 shows an exemplary graphical user interface during movement of an image corresponding a piece of content into an area indicating a user's disinterest in the piece of content, in accordance with one embodiment of the present invention. FIG. 5 depicts exemplary graphical user interface 500 with an image corresponding to a piece of content being moved (e.g., dragged into) an area corresponding to user being disinterested in the piece of content. In one embodiment, exemplary graphical user interface 500 includes elements similar to exemplary graphical user interface 400.

In one embodiment, exemplary graphical user interface 500 shows a portion of piece of content image 340 being moved into area 304. In one exemplary embodiment, area 304 is highlighted (e.g., a background color and outline of area 304 are changed in color) based on a portion of piece of image 340 being moved within area 304. Piece of content image 340 may then be added to area 304 if a user releases (e.g., via lifting his or her finger from a touch screen) piece of content image 340. Piece of content image 340 may then be displayed as one of piece of content images 310 in area 304.

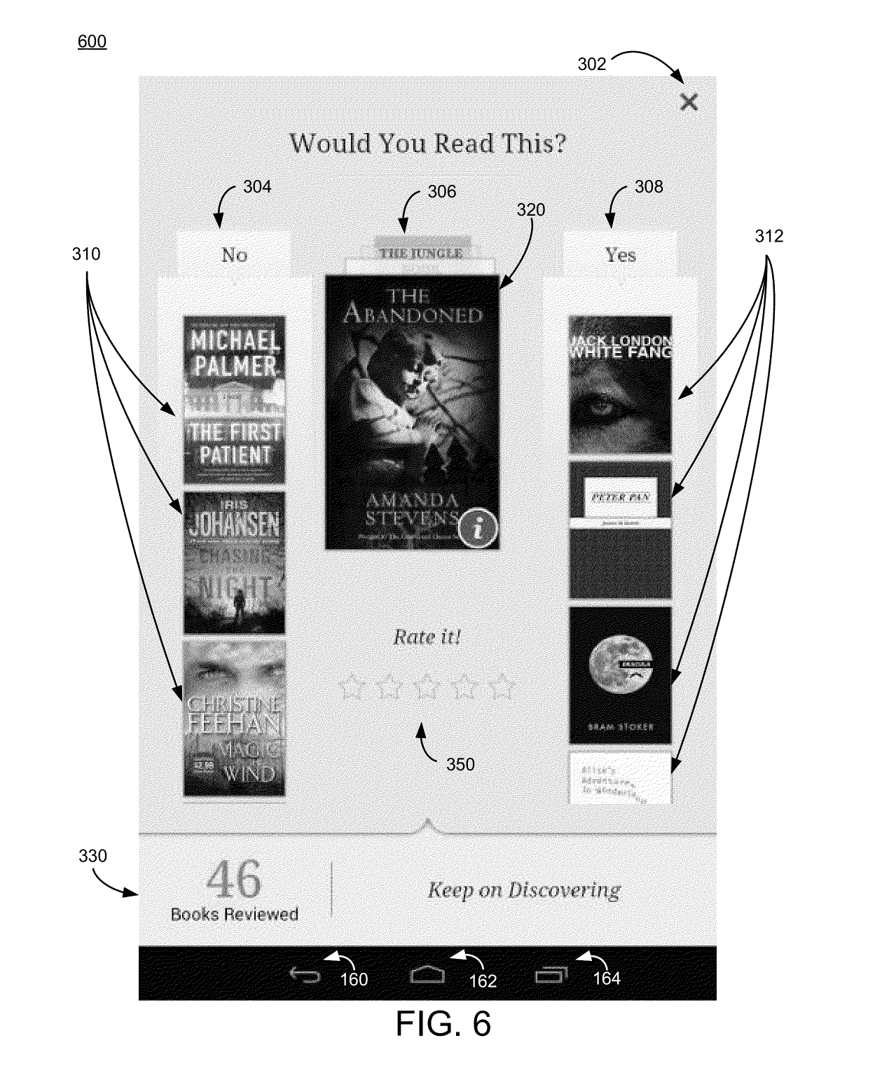

FIG. 6 shows an exemplary graphical user interface for inputting a rating of a piece of content, in accordance with one embodiment of the present invention. FIG. 6 depicts an exemplary graphical user interface 600 operable for allowing a user to rate a piece of content. In one embodiment, exemplary graphical user interface 600 includes elements similar to exemplary graphical user interface 500.

Graphical user interface 600 comprises rating area 350. In one embodiment, rating area 350 may be rendered or displayed upon a selection of a (“I've read it”) button 324. In one exemplary embodiment, rating area includes five stars each of which are selectable to allow a user to enter a star rating for the piece of content corresponding to piece of content image 320.

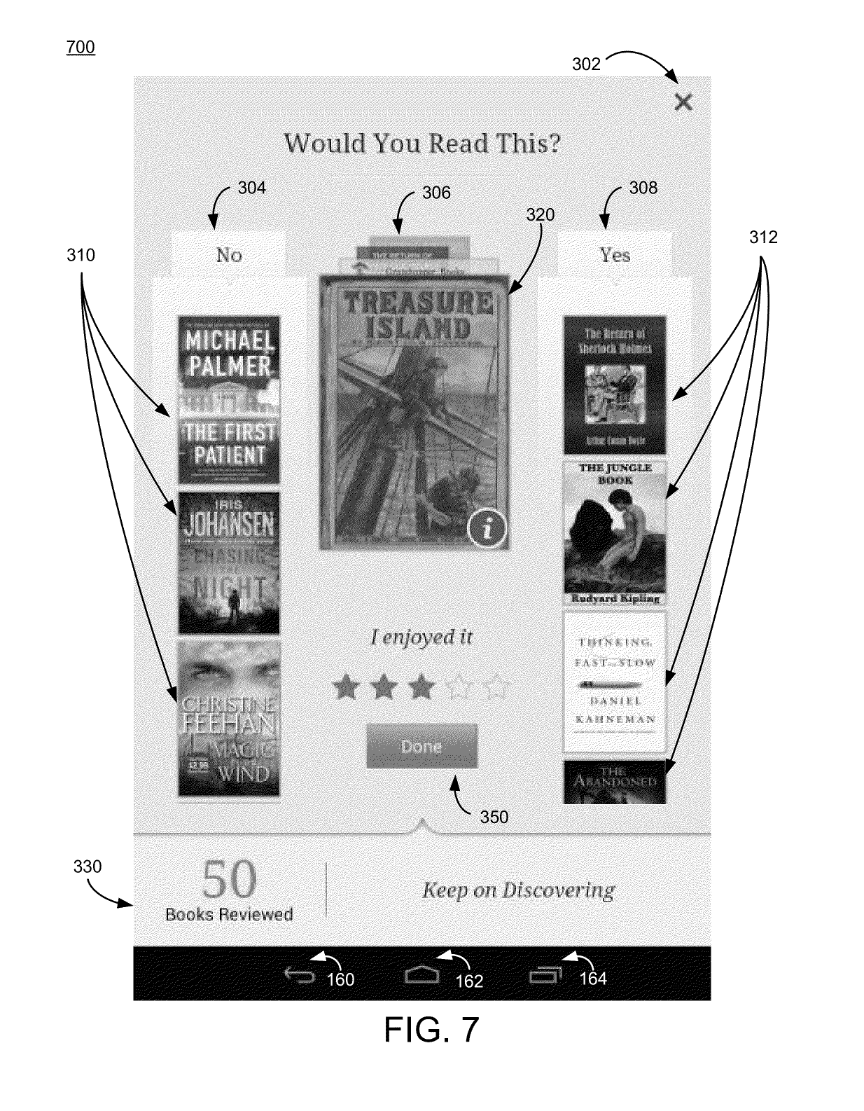

FIG. 7 shows an exemplary graphical user interface for inputting a rating of a piece of content after a rating has been selected, in accordance with one embodiment of the present invention. FIG. 7 depicts an exemplary graphical user interface 700 comprising an updated ratings area 350 after a user has selected a rating. In one embodiment, exemplary graphical user interface 700 includes elements similar to exemplary graphical user interface 600.

Exemplary graphical user interface 700 includes updated ratings area 350. Updated ratings area 350 displays the selected rating (e.g., as chosen by a user). In one embodiment, updated ratings area 350 includes text corresponding to the rating. For example, one star corresponds to “I didn't like it,” two stars corresponds to “It was okay,” three stars corresponds to “I enjoyed it,” four stars corresponds to “I'd recommend it,” and five stars corresponds to “Loved it!” Updated ratings area 350 may further include a button (e.g., Done button) to allow a user to submit his or her rating.

After a rating has been submitted or chosen by a user, piece of content image 320 may be moved or animated on screen moving to area 304 or area 308 depending on the rating. In one embodiment, if a two star or one star rating is selected, piece of content image 320 is animated moving into area 304 and piece of content image 320 is displayed in area 304. In one exemplary embodiment, if a three star, four star, or five star rating is selected, piece of content image 320 is animated moving into area 308 and piece of content image 320 is displayed in area 308. A user profile may then be updated based on the rating of the piece of content corresponding to piece of content image 320. Recommendations may be updated based upon the updated profile.

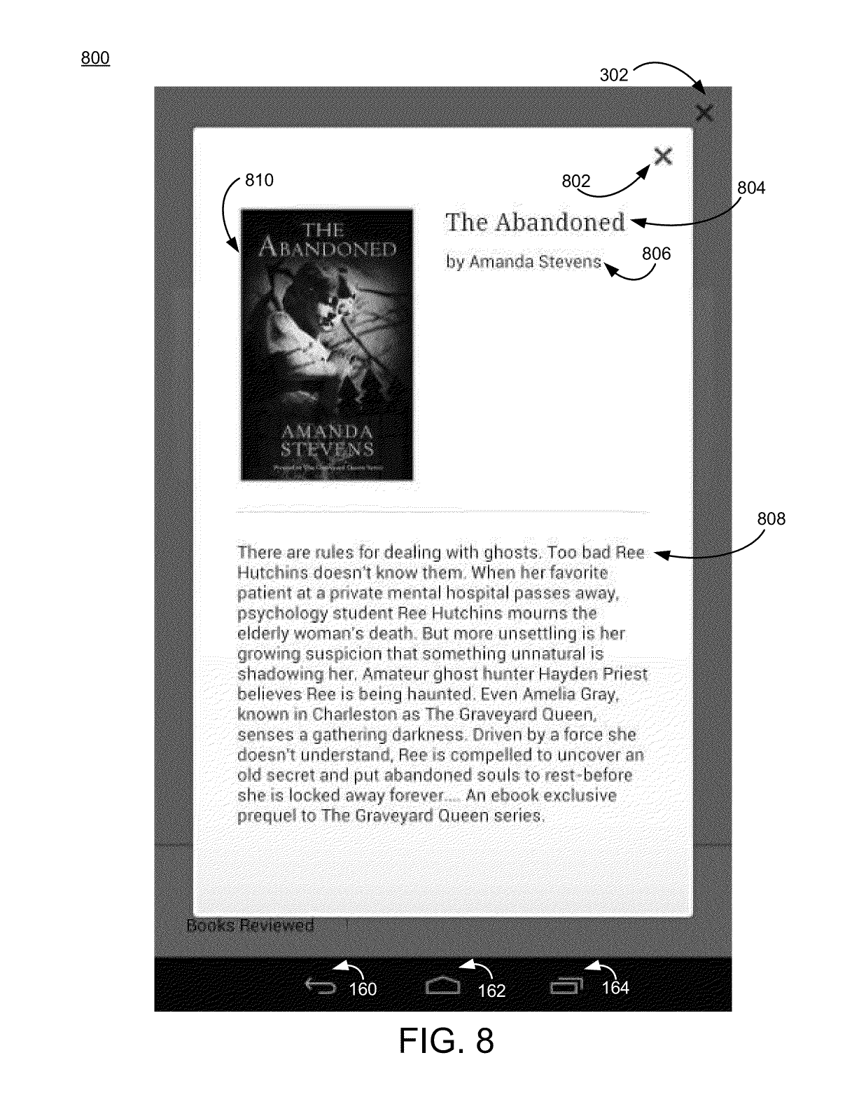

FIG. 8 shows an exemplary graphical user interface for rendering a description of a piece of content, in accordance with one embodiment of the present invention. FIG. 8 depicts exemplary graphical user interface 800 comprising information about a piece of content. In one embodiment, exemplary graphical user interface 800 includes elements similar to exemplary graphical user interface 700.

In one embodiment, exemplary graphical user interface 800 comprises close button 302, close button 802, title area 804, author area 806, description area 808, and piece of content image 810.

Close button 802 is operable for closing a portion of graphical user interface 800 and exiting the portion of graphical user interface 800 including title area 804, author area 806, description area 808, and piece of content image 810. In one embodiment, graphical user interface 300 is rendered upon closing of the portion of graphical user interface 800.

Title area 804 is operable to display a title of a piece of content. Author area 806 is operable to display an author, source, or other source indicator of a piece of content. Description area 808 is operable to display description, summary, or other corresponding information about a piece of content. In one embodiment, piece of content image 810 comprises an image corresponding to the piece of content and may include a book or electronic publication cover image, music album image, artist image, author image, video image, etc.

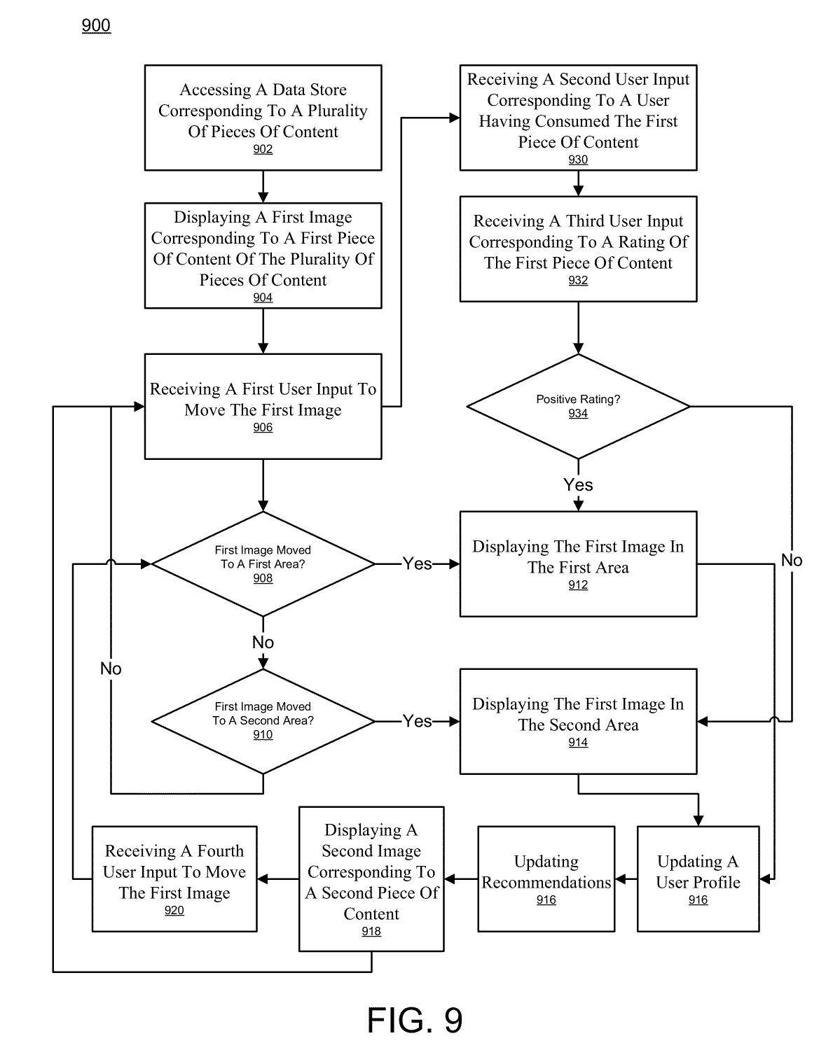

With reference to FIG. 9, flowchart 900 illustrates example functions used by various embodiments of the present invention for displaying graphical user interfaces. Although specific function blocks (“blocks”) are disclosed in flowchart 900, such steps are examples. That is, embodiments are well suited to performing various other blocks or variations of the blocks recited in flowchart 900. It is appreciated that the blocks in flowchart 900 may be performed in an order different than presented, and that not all of the blocks in flowchart 900 may be performed.

FIG. 9 shows a flowchart of an exemplary computer controlled process for rendering a graphical user interface for configuring a user profile, in accordance with one embodiment of the present invention. In one embodiment, FIG. 9 depicts a process 900 for configuration a user profile (e.g., a user's taste or preferences portion of a user profile) which may be used to recommend pieces of content to a user.

At block 902, a data store corresponding to a plurality of pieces of content is accessed. In one exemplary embodiment, the pieces of content are electronic publications. The data store may further comprise images corresponding to each of the plurality of pieces of content.

At block 904, a first image corresponding to a first piece of content of the plurality of pieces of content is displayed. In one exemplary embodiment, the first image is an electronic publication cover image.

At block 906, a first user input to move the first image is received. The first user input may correspond to a user pressing holding and dragging the first image, as described herein.

At block 908, whether the first image is moved (e.g., and released) into a first area (e.g., area 308) is determined. In one exemplary embodiment, the first area is operable to comprise a first set of respective images corresponding to one or more electronic publications associated with an indicated or expressed user interest. If the first image is moved to the first area, block 912 may be performed. If the first image is not moved to the first area, block 910 may be performed.

At block 910, whether the first image is moved (e.g., and released) into a second area (e.g., area 304) is determined. In one exemplary embodiment, the second area is operable to comprise respective images a second set of respective images corresponding to one or more electronic publications associated with an indicated or expressed user disinterest. If the first image is moved to the second area, block 914 may be performed. If the first image is not moved to the second area, block 906 may be performed.

At block 912, the first image is displayed in the first area. The first image may be displayed with a portion of the first set of respective images corresponding to one or more electronic publications associated with an indicated or expressed user interest, as described herein.

At block 914, the first image is displayed in the second area. The first image may be displayed with a portion of the second set of respective images corresponding to one or more electronic publications associated with an indicated or expressed user interest, as described herein.

At block 918, a second image corresponding to a second piece of content is displayed. As described herein, the second image may correspond to a new piece of content being presented to a user to be rated or an interested expressed associated with the piece of content.

At block 916, a user profile is updated. In one embodiment, the user profile is updated with a first indicator to reflect a user's interest when the first image is moved to the first area. The user profile may be updated with a second indicator to reflect a user's disinterested when the first image is moved to the second area.

At block 917, recommendations are updated based on the user profile, as described herein.

At block 930, a second user input corresponding to a user having consumed the first piece of content is received (e.g., clicking an “I've read it” button), as described herein.

At block 932, a third user input corresponding to a rating of the first piece of content is received. The third user input may comprise a star rating of the piece of content, as described herein.

At block 934, whether a positive rating is received is determined, as described herein. If a positive rating is received, block 912 may be performed. If a non-positive (e.g., or negative) rating is received, block 914 may be performed.

At block 920, a fourth user input to move the first image is received. The fourth user input may comprise moving the first image from a first area (e.g., area 304) to another area (e.g., area 308), as described herein.

FIG. 10 illustrates exemplary components used by various embodiments of the present invention. Although specific components are disclosed in computing system environment 1000, it should be appreciated that such components are exemplary. That is, embodiments of the present invention are well suited to having various other components or variations of the components recited in computing system environment 1000. It is appreciated that the components in computing system environment 1000 may operate with other components than those presented, and that not all of the components of system 1000 may be required to achieve the goals of computing system environment 1000.

FIG. 10 shows a block diagram of an exemplary computer system and corresponding modules, in accordance with one embodiment of the present invention. With reference to FIG. 10, an exemplary system module for implementing embodiments includes a general purpose computing system environment, such as computing system environment 1000. Computing system environment 1000 may include, but is not limited to, servers, desktop computers, laptops, tablet PCs, tablet computing devices, mobile devices, and smartphones. In its most basic configuration, computing system environment 1000 typically includes at least one processing unit 1002 and computer readable storage medium 1004. Depending on the exact configuration and type of computing system environment, computer readable storage medium 1004 may be volatile (such as RAM), non-volatile (such as ROM, flash memory, etc.) or some combination of the two. Portions of computer readable storage medium 1004 when executed facilitate efficient execution of memory operations or requests for groups of threads. Computing system environment 1000 may further include a power source (e.g., battery) (not shown) operable to allow computing system environment 1000 to be movable and mobile while operating.

Additionally, computing system environment 1000 may also have additional features/functionality. For example, computing system environment 1000 may also include additional storage (removable and/or non-removable) including, but not limited to, magnetic or optical disks or tape. Such additional storage is illustrated in FIG. 10 by removable storage 1008 and non-removable storage 1010. Computer storage media includes volatile and nonvolatile, removable and non-removable media implemented in any method or technology for storage of information such as computer readable instructions, data structures, program modules or other data. Computer readable medium 1004, removable storage 1008 and non-removable storage 1010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1000. Any such computer storage media may be part of computing system environment 1000.

Computing system environment 1000 may also contain communications connection(s) 1012 that allow it to communicate with other devices. Communications connection(s) 1012 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 1012 may allow computing system environment 1000 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), Near Field Communication (NFC), Code Division Multiple Access (CDMA), Global System for Mobile Communications (GSM), Long-term Evolution (LTE), Worldwide Interoperability for Microwave Access (WiMax), wide area networks (WAN) such as the internet, serial, and universal serial bus (USB). It is appreciated the various network types that communication connection(s) 1012 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 1000 may also have input device(s) 1014 such as a touch screen (e.g., capacitive touch screen), keyboard, mouse, pen, voice input device, touch input device, remote control, camera, etc. Output device(s) 1016 such as a display (e.g., touch screen), speakers, etc. may also be included. All these devices are well known in the art and are not discussed at length.

In one embodiment, computer readable storage medium 1004 includes data store module 1020, data store access module 1022, display module 1024, input module 1026, interest determination module 1028, and profile module 1030.

Data store access 1022 module is operable to access data store module 1020 (e.g., upon launch of a user profile configuration application or a based on a request from input module 1026 or profile module 1030). Data store module 1022 is operable to store data (e.g., images, information, etc.) corresponding to a plurality of pieces of content (e.g., electronic publications, audio, video, websites, etc.), as described herein.

Display module 1024 is operable to display a respective image for each of the plurality of pieces of content, as described herein. In one embodiment, display module 1024 is further operable to display the first respective image in a first area of the display device in response to the first respective image being moved to the first area of the display device. In one exemplary embodiment, display module 1024 is further operable to display the first respective image in the second area of the display device in response to the first respective image being moved to a second area of the display device. In another embodiment, display module 1024 is operable to display a second respective image corresponding to the piece of content of the plurality of pieces of content in the first area of the display device in response to input module 1026 receiving the rating corresponding to the piece of content of the plurality of pieces of content.

Input module 1026 is operable to receive a motion input associated with a first respective image, as described herein. In one embodiment, input module 1026 is further operable for receiving a second motion input with respect to the first respective image moving from at least one of the first area of the display device and the second area of the display device. In one exemplary embodiment, input module 1026 is further operable to receive input of a rating corresponding a piece of content of the plurality of pieces of content, as described herein.

Interest determination module 1028 is operable to determine whether the first respective image has been moved to at least one of a first area of a display device and second area of the display device, as described herein. In one embodiment, the first area of a display device corresponds to the user being interested in a respective piece of electronic content corresponding to the first respective image and the second area of the display device corresponds to the user being disinterested in the respective piece of electronic content corresponding to the first respective image.

Profile module 1030 is operable to update a user profile based on a determination by interest determination module 1028, as described herein. In one embodiment, profile module 103 is operable to update a user profile stored in data store module 1020. Recommendation module 1032 is operable to generate and update (e.g., add or remove) recommended pieces of content from a set of recommendations based on the user profile, as described herein.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for rendering a graphical user interface, said method comprising:
accessing, within a mobile device, a data store corresponding to a plurality of pieces of content;
displaying a first image corresponding to a first piece of content of said plurality of pieces of content, wherein said first image is displayed in a first area of a display device;
receiving a first user input corresponding to a movement of said first image;
determining whether said first image has been moved into a second area of said display device;
in response to said first image being moved into said second area of said display device, displaying the first image in said second area of said display device; and
updating a user profile with a first indicator that said user is interested in said first piece of content corresponding to said first image.

2. The method as described in claim 1, further comprising:
determining whether said first image has been moved in a third area of said display device;
in response to said first image being moved into said third area of said display device, displaying said first image in said third area of said display device; and
updating said user profile with a second indicator that said user is disinterested in said first piece of content corresponding to said first image.

3. The method as described in claim 1, further comprising:
displaying a second image corresponding to a second piece of content of said plurality of pieces of content.

4. The method as described in claim 2, further comprising:
displaying a second image corresponding to a second piece of content of said plurality of pieces of content.

5. The method as described in claim 1, further comprising:
receiving a second user input corresponding to a user indication that said user has previously consumed said first piece of content.

6. The method as described in claim 5, further comprising:
receiving a third user input corresponding to a rating of said first piece of content.

7. The method as described in claim 1, further comprising:
receiving a second user input to move said first image from said second area of said display device;
in response to said second user input, determining whether said first image has been moved in a third area of said display device;
in response to said first image being moved into said third area of said display device, displaying said first image in said third area of said display device; and
updating said user profile with a second indicator that said user is disinterested in said first piece of content corresponding to said first image.

8. A method of configuring a user profile via a graphical user interface, said method comprising:
accessing, within a mobile device, a data store corresponding to a plurality of electronic publications;
displaying a first electronic publication cover image corresponding to a first electronic publication of said plurality of electronic publication, wherein said first electronic publication cover image is displayed in a first area of a display device;
receiving a first user input corresponding to a movement of said first electronic publication cover image;
determining whether said first electronic publication cover image has been moved into a second area of said display device, wherein said second area is operable to display a first set of respective images corresponding to electronic publications associated with an expressed user interest;
in response to said first electronic publication cover image being moved into said second area of said display device, displaying the first electronic publication cover image in said second area of said display device; and
updating a user profile with a first indicator that said user is interested in said first electronic publication corresponding to said first electronic publication cover image.

9. A method as described in claim 8, further comprising:
determining whether said first electronic publication cover image has been moved in a third area of said display device, wherein said third area is operable to display a second set of respective images corresponding to electronic publications that a user has expressed a disinterest in;
in response to said first electronic publication cover image being moved into said third area of said display device, displaying said first electronic publication cover image in said third area of said display device; and
updating said user profile with a second indicator that said user is disinterested in said first electronic publication corresponding to said first image.

10. A method as described in claim 8 further comprising:
displaying a second electronic publication cover image corresponding to a second piece of content of said plurality of pieces of content, wherein said second electronic publication cover image displayed in said first area of said display device.

11. A method as described in claim 10 further comprising:
receiving a second user input corresponding to a user indication that said user has previously consumed said first electronic publication.

12. The method as described in claim 11 further comprising:
receiving a third user input corresponding to a rating of said first piece of content.

13. The method as described in claim 8 further comprising:
receiving a second user input to move said first electronic publication cover image from said second area of said display device;
in response to said second user input, determining whether said first electronic publication cover image has been moved to a third area of said display device;
in response to said first electronic publication cover image being moved into said third area of said display device, displaying said first electronic publication cover image in said third area of said display device; and
updating said user profile with a second indicator that said user is disinterested in said first publication corresponding to said first electronic publication cover image.

14. The method as described in claim 9 further comprising:
receiving a second user input to move said first electronic publication cover image from said third area of said display device;
in response to said second user input, determining whether said first electronic publication cover image has been moved into said second area of said display device;
in response to said first electronic publication cover image being moved into said second area of said display device, displaying said first electronic publication cover image in said second area of said display device; and
updating said user profile with a second indicator that said user is interested in said first publication corresponding to said first electronic publication cover image.

15. A system for rendering a graphical user interface, said system comprising:
a data store access module operable to access a data store corresponding to a plurality of pieces of electronic content;
a display module operable to display a respective image for each of said plurality of pieces of content;
an input module operable to receive a motion input associated with a first respective image;
an interest determination module operable to determine whether said first respective image has been moved to at least one of a first area of a display device and second area of said display device, wherein said first area of a display device corresponds to said user being interested in a respective piece of electronic content corresponding to said first respective image and said second area of said display device corresponds to said user being disinterested in said respective piece of electronic content corresponding to said first respective image; and
a profile module operable to update a user profile based on a determination by said interest determination module.

16. The system as described in claim 15, wherein said display module is further operable to display said first respective image in said first area of said display device in response to said first respective image being moved to said first area of said display device.

17. The system as described in claim 15, wherein said display module is further operable to display said first respective image in said second area of said display device in response to said first respective image being moved to said second area of said display device.

18. The system as described in claim 15, wherein said input module is further operable for receiving a second motion input with respect to said first respective image moving from at least one of said first area of said display device and said second area of said display device.

19. The system as described in claim 15, wherein said input module is further operable to receive input of a rating corresponding a piece of content of said plurality of pieces of content.

20. The system as described in claim 19, wherein said display module is operable to display a second respective image corresponding to said piece of content of said plurality of pieces of content in said first area of said display device in response to said input module receiving said rating corresponding to said piece of content of said plurality of pieces of content.
